(19) United States
(12) Patent Application Publication
(10) Pub. No.: US 2017/0290328 A1
(43) Pub. Date: Oct. 12, 2017

(54) COMPOSITIONS AND METHODS FOR APPLYING AGRICULTURAL PRODUCTS

(71) Applicant: AG PRECISION FORMULATORS, Middleton, WI (US)

(72) Inventors: Keith R. ROWLEY, Madison, WI (US); Nongnuch SUTIVISEDSAK, Madison, WI (US); Patrick M. MCMULLAN, Grimes, IA (US)

(21) Appl. No.: 15/514,260

(22) PCT Filed: Oct. 1, 2015
(86) PCT No.: PCT/US15/53402

§ 371 Date: Mar. 24, 2017

Related U.S. Application Data
(60) Provisional application No. 62/058,979, filed on Oct. 2, 2014.

(51) Int. Cl. A01N 25/02; A01N 57/20; A01N 43/54; A01N 37/40; A01N 25/30; A01N 43/40

(52) U.S. Cl. CPC A01N 25/02; A01N 25/30; A01N 43/40; A01N 43/54; A01N 37/40; A01N 57/20; A01N 2300/00

(57) ABSTRACT

The present disclosure relates to compositions, systems, and methods for applying agricultural products. In particular, the present disclosure relates to compositions comprising agricultural products (e.g., herbicides, insecticides, pesticides, or fungicides) and plant extracts (e.g., essential oils) and uses thereof to increase efficacy of the agricultural products.

The present Application claims priority to U.S. Provisional Patent Application Ser. No. 62/058,979 filed Oct. 2, 2014, the disclosure of which is herein incorporated by reference in its entirety.

### FIELD OF THE INVENTION

The present disclosure relates to compositions, systems, and methods for applying agricultural products. In particular, the present disclosure relates to compositions comprising agricultural products (e.g., herbicides, insecticides, pesticides, or fungicides) and plant extracts (e.g., essential oils) and uses thereof to increase efficacy of the agricultural products.

### BACKGROUND

When growing crops in a field, it is important to kill or control the growth of undesirable plants (weeds) in the field. If not controlled, the weeds compete with crop plants for essential resources such as soil nutrients, water and sunlight. By removing a fraction of the resources or otherwise reducing the availability of these resources to crop plants, the weeds restrict crop growth, resulting in loss of crop yield.

Timely and judicious use of herbicides can provide weed control to minimize crop losses and production costs. Herbicides are useful for control of a large variety of weeds.

Adjuvants are materials that enhance the action of herbicides by promoting absorption and translocation and by complexing antagonistic metal ions in the water used to make the herbicide solution.

Additional adjuvants and enhancers are needed to improve the efficacy of herbicides. Preferred enhancers are safe, non-toxic, inexpensive, and effective.

### SUMMARY OF THE INVENTION

The present disclosure relates to compositions, systems, and methods for applying agricultural products. In particular, the present disclosure relates to compositions comprising agricultural products (e.g., herbicides, insecticides, pesticides, or fungicides) and plant extracts (e.g., essential oils) and uses thereof to increase efficacy of the agricultural products.

For example, in some embodiments, the present invention provides a herbicide composition comprising: a) at least one agricultural product (e.g., herbicide, pesticide, or fungicide); b) at least one adjuvant; c) at least one emulsifier; and d) at least one enhancer. The present invention is not limited to a particular enhancer, adjuvant, emulsifier, or agricultural product. Exemplary enhancers, adjuvants, emulsifiers, and agricultural products are described herein. In some embodiments, the adjuvant is a modified (e.g., methylated) seed oil. In some embodiments, the enhancer is a plant extract (e.g., essential oil (e.g., methyl salicylate)), a terpene, or a lecithin. In some embodiments, the enhancer is present at a concentration of between 1 and 20% (e.g. between 5 and 10%). In some embodiments, the emulsifier is A-110, alkylphenol ethoxylates, alcohol ethoxylates, polyoxyethylene glycol estehr, polyl fatty acid esters, alkyl ethoxylates, alkylarylpolyoxyalkane ether, sorbitan fatty acid esters alkylphenol ethyoxylates, tall fatty acids, ethoxylate alkyl aryl phosphate, polyoxyethylene sorbitan fatty acid esters, or nonylphenol ethoxylates. In some embodiments, the emulsifier is present at a concentration of between 1 and 60%.

Additional embodiments provide a dilution of the composition in water (e.g., to a concentration of 0.25 to 1.0% by volume).

Yet other embodiments provide kits and/or systems comprising any of the aforementioned compositions or dilutions; and a device for applying the composition or dilution thereof (e.g., a sprayer).

Further embodiments provide a method of treating a plant (e.g., killing a weed, killing a pest, killing a fungus, or killing an insect), or enhancing the growth of a plant, comprising applying any of the aforementioned compositions or a dilution thereof to a plant (e.g., an agricultural crop). In some embodiments, the composition is applied prior to seeding an agricultural crop, after an agricultural crop has emerged, or after harvest of an agricultural crop.

Additional embodiments are described herein.

### DETAILED DESCRIPTION

The present disclosure relates to compositions, systems, and methods for applying agricultural products. In particular, the present disclosure relates to compositions comprising agricultural products (e.g., herbicides, insecticides, pesticides, or fungicides) and plant extracts (e.g., essential oils) and uses thereof to increase efficacy of the agricultural products. Embodiments of the present disclosure provide compositions comprising one or more agricultural products (e.g., herbicides, insecticides, pesticides, or fungicides), an adjuvant, an emulsifier, and an enhancer (e.g., essential oil). In some embodiments, compositions comprise one or more additional active ingredients (e.g., pesticides, insecticides, fungicides, etc.). The present disclosure further provides systems and methods of utilizing the compositions in agriculture, research, and landscaping applications.

### I. Compositions

Compositions of embodiments of the present disclosure comprise one or more of the following components: a) one or more agricultural products; b) one or more adjuvants; c) an emulsifier; and d) one or more enhancers (e.g., plant extracts (e.g., essential oils)). While not limited to a particular mechanism, it is contemplated that the addition of essential oils increases the efficacy of the agricultural product. In some embodiments, the additional of an essential oil permits a decrease in agricultural product and/or adjuvant concentration. In some embodiments, essential oils mask the odor of the herbicide and/or adjuvant.

Exemplary, non-limiting examples of compositions, methods of formulating, and systems are described below.

### A. Agricultural Products

Embodiments of the present disclosure provide compositions comprising one or more agricultural products (e.g., herbicides, pesticides, or fungicides). Exemplary agricultural products are described below.

i. Herbicides

The present disclosure is not limited to a particular herbicide. Examples include, but are not limited to, amide herbicides (e.g., allidochlor, amicarbazone, beflubutamid, benzadox, benzipram, bromobutide, cafenstrole, CDEA, cyprazole, dimethenamid (e.g., dimethenamid-P), diphenamid, epronaz, etnipromid, fentrazamide, flucarbazone, flupoxam, fomesafen, halosafen, huangcaoling, isocarbamid, isoxaben, napropamide, naptalam, pethoxamid, propyzamide, quinonamid, saflufenacil, tebutam); anilide herbicides (e.g., chloranocryl, cisanilide, clomeprop, cypromid, diflufenican, erlujixiancaoan, etobenzanid, fenasulam, flufenacet, flufenican, ipfencarbazone, mefenacet, mefluidide, metamifop, monalide, naproanilide, pentanochlor, picolinafen, propanil, sulfentrazone); arylalanine herbicides (e.g., benzoylprop, flamprop (e.g., flamprop-M)); chloroacetanilide herbicides (e.g., acetochlor, alachlor, butachlor, butenachlor, delachlor, diethatyl, dimethachlor, ethachlor, ethaprochlor, metazachlor, metolachlor (e.g., S-metolachlor), pretilachlor, propachlor, propisochlor, prynachlor, terbuchlor, thenylchlor, xylachlor); sulfonanilide herbicides (e.g., benzofluor, cloransulam, diclosulam, florasulam, flumetsulam, metosulam, perfluidone, pyrimisulfan, profluazol); sulfonamide herbicides (e.g., asulam, carbasulam, fenasulam, oryzalin, penoxsulam, pyroxsulam, see also sulfonylurea herbicides); thioamide herbicides (e.g., bencarbazone, chlorthiamid); antibiotic herbicides (e.g., bilanafos); aromatic acid herbicides (e.g., benzoic acid herbicides (e.g., chloramben, dicamba, 2,3,6-TBA, tricamba); pyrimidinyloxybenzoic acid herbicides (e.g., bispyribac, pyriminobac);

pyrimidinylthiobenzoic acid herbicides (e.g., pyrithiobac); phthalic acid herbicides (e.g., chlorthal); picolinic acid herbicides (e.g., aminopyralid, clopyralid, picloram); quinolinecarboxylic acid herbicides (e.g., quinclorac, quinmerac)); arsenical herbicides (e.g., cacodylic acid, CMA, DSMA, hexaflurate, MAA, MAMA, MSMA, potassium arsenite, sodium arsenite); benzoylcyclohexanedione herbicides (e.g., ketospiradox, mesotrione, sulcotrione, tefuryltrione, tembotrione); benzofuranyl alkylsulfonate herbicides (e.g., benfuresate, ethofumesate); benzothiazole herbicides (e.g., benazolin, benzthiazuron, fenthiaprop, mefenacet, methabenzthiazuron); carbamate herbicides (e.g., asulam, carboxazole, chlorprocarb, dichlormate, fenasulam, karbutilate, terbucarb); carbanilate herbicides (e.g., barban, BCPC,
carbasulam, carbetamide, CEPC, chlorbufam, chlorpropham, CPPC, desmedipham, phenisopham, phenmedipham, phenmedipham-ethyl, propham, swep); cyclohexene oxime herbicides (e.g., alloxydim, butroxydim, clethodim, cloproxydim, cycloxydim, profoxydim, sethoxydim, tepraloxydim, tralkoxydim); cyclopropylisoxazole herbicides (e.g., isoxachlortole, isoxaflutole); dicarboximide herbicides (e.g., cinidon-ethyl, flumezin, flumiclorac, flumioxazin, flumipropyn, see also uracil herbicides); dinitroaniline herbicides (e.g., benfluralin, butralin, chlornidine, dinitramine, dipropalin, ethalfluralin, fluchloralin, isopropalin, methalpropalin, nitralin, oryzalin, pendimethalin, prodiamine, profluralin, trifluralin); dinitrophenol herbicides (e.g., dinofenate, dinoprop, dinosam, dinoseb, dinoterb, DNOC, etinofen, medinoterb); diphenyl ether herbicides (e.g., ethoxyfen); nitrophenyl ether herbicides (e.g., acifluorfen, aclonifen, bifenox, chlomethoxyfen, chlornitrofen, etnipromid, fluorodifen, fluoroglycofen, fluoronitrofen, fomesafen, fucaomi, furyloxyfen, halosafen, lactofen, nitrofen, nitrofluorfen, oxyfluorfen); dithiocarbamate herbicides (e.g., dazomet, metam); halogenated aliphatic herbicides (e.g., alorac, chloropon, dalapon, flupropanate, hexachloroacetone, methyl bromide, methyl iodide,
monochloroacetic acid, SMA, TCA); imidazolinone herbicides (e.g., imazamethabenz, imazamox, imazapic, imazapyr, imazaquin, imazethapyr); inorganic herbicides (e.g., ammonium sulfamate, borax, calcium chlorate, copper sulfate, ferrous sulfate, potassium azide, potassium cyanate, sodium azide, sodium chlorate, sulfuric acid); nitrile herbicides (e.g., bromobonil, bromoxynil, chloroxynil, dichlobenil, iodobonil, ioxynil, pyraclonil); organophosphorus herbicides (e.g., amiprofos-methyl, amiprophos, anilofos, bensulide, bilanafos, butamifos, 2,4-DEP, DMPA, EBEP, fosamine, glufosinate (e.g., glufosinate-P, glyphosate, huangcaoling
piperophos); oxadiazolone herbicides (e.g., dimefuron, methazole, oxadiargyl, oxadiazon); oxazole herbicides (e.g., carboxazole, fenoxasulfone, isouron, isoxaben, isoxachlortole, isoxaflutole, methiozolin, monisouron, pyroxasulfone, topramezone); phenoxy herbicides (e.g., bromofenoxim, clomeprop, 2,4-DEB, 2,4-DEP, difenopenten, disul, erbon, etnipromid, fenteracol, trifopsime); phenoxyacetic herbicides (e.g., 4-CPA, 2,4-D, 3,4-DA, MCPA, MCPA-thioethyl, 2,4,5-T); phenoxybutyric herbicides (e.g., 4-CPB, 2,4-DB, 3,4-DB, MCPB, 2,4,5-TB);
phenoxybutyric herbicides (e.g., 4-CPB, 2,4-DB, 3,4-DB, MCPB, 2,4,5-TB); phenoxypropionic herbicides (e.g., cloprop, 4-CPP, dichlorprop (e.g., dichlorprop-P), 3,4-DP, fenoprop, mecoprop (e.g., mecoprop-P); aryloxyphenoxypropionic herbicides (e.g., chlorazifop, clodinafop, clofop, cyhalofop, diclofop, fenoxaprop (e.g., fenoxaprop-P); fenthiaprop, fluazifop (e.g., fluazifop-P), haloxyfop (e.g., haloxyfop-P), isoxapyrifop, metamifop, propaquizafop, quizalofop (e.g., quizalofop-P), trifop); phenylenediamine herbicides (e.g., dinitramine, prodiamine); pyrazole herbicides (e.g., azimsulfuron, difenzoquat, halosulfuron, metazachlor, metazosulfuron, pyrazosulfuron, pyroxasulfone); pyrazole herbicides (e.g., benzofenap, pyrasulfotole, pyrazolynate, pyrazoxyfen, topramezone); phenylpyrazole herbicides (e.g., fluazolate, nipyraclofen, pinoxaden, pyraflufen); pyridazine herbicides (e.g., credazine, pyridafol, pyridate); pyridazinone herbicides (e.g., brompyrazon, chloridazon, dimidazon, flufenpyr, metflurazon, norflurazon, oxapyrazon, pydanon); pyridine herbicides (e.g., aminopyralid, cliodinate, clopyralid, diflufenican, dithiopyr, flufenican, fluroxypyr, haloxydine picloram, picolinafen, pyriclor, pyroxsulam, thiazopyr, triclopyr); pyrimidinediamine herbicides (e.g., iprymidam, tioclorim); pyrimidinyloxybenzylamine herbicides (e.g., pyribambenz-isopropyl, pyribambenzpropyl); quaternary ammonium herbicides (e.g., cyperquat, diethamquat, difenzoquat, diquat, morfamquat, paraquat); thiocarbamate herbicides (e.g., butylate, cycloate, diallate, EPTC, esprocarb, ethiolate, isopolinate, methiobencarb, molinate, orbencarb, pebulate, prosulfocarb, pyributicarb, sulfallate, thiobencarb, tiocarbazil, tri-allate, vernolate); thiocarbonate herbicides (e.g., dimexano, EXD, proxan); thiourea herbicides (e.g., methiuron); triazine herbicides (e.g., dipropetryn, fucaojing, trihydroxytriazine); chlorotriazine herbicides (e.g., atrazine, chlorazine, cyanazine, cyprazine, eglinazine, ipazine, mesoprazine, procyazine, proglinazine, propazine, sebuthylazine, simazine, terbuthylazine, trietazine); fluoroalkyltriazine herbicides (e.g., indaziflam, triaziflam); methoxytriazine herbicides (e.g., atraton, methometon, prometon, secbumeton, simeton, terbumeton); methylthiotriazine herbicides (e.g., ametryn, aziprotryne, cyanatryn, desmetryn, dimethametryn, methoprotryne, prometryn, simetryn, terbutryn); triazinone herbicides (e.g., ametridione, amibuzin, ethiozin, hexazinone, isomethiozin, metamitron, metribuzin); triazole herbicides (e.g., amitrole, cafenstrole, epronaz, flupoxam); triazolone herbicides (e.g., amicarbazone, bencarbazone, carfentrazone, flucarbazone, ipfencarbazone, propoxycarbazone, sulfentrazone, thiencarbazone); triazolopyrimidine herbicides (e.g., cloransulam, diclosulam, florasulam, flumetsulam, metosulam, penoxsulam, pyroxsulam); uracil herbicides (e.g., benzfendizone, bromacil, butafenacil, flupropacil, isocil, lenacil, saflufenacil, terbacil); urea herbicides (e.g., benzthiazuron, cumyluron, cycluron,
dichloralurea, diflufenzopyr, isonoruron, isouron, methabenzthiazuron, monisouron, noruron); phenylurea herbicides (e.g., anisuron, buturon, chlorbromuron, chloreturon, chlorotoluron, chloroxuron, daimuron, difenoxuron, dimefuron, diuron, fenuron, fluometuron, fluothiuron, isoproturon, linuron, methiuron, methyldymron, metobenzuron, metobromuron, metoxuron, monolinuron, monuron, neburon, parafluron, phenobenzuron, siduron, tetrafluron, thidiazuron); sulfonylurea herbicides (e.g., pyrimidinylsulfonylurea herbicides (e.g., amidosulfuron, azimsulfuron, bensulfuron, chlorimuron, cyclosulfamuron, ethoxysulfuron, flazasulfuron,
flucetosulfuron, flupyrsulfuron, foramsulfuron, halosulfuron, imazosulfuron, mesosulfuron, metazosulfuron, methiopyrisulfuron, nicosulfuron, orthosulfamuron, oxasulfuron, primisulfuron, propyrisulfuron, pyrazosulfuron, rimsulfuron, sulfometuron, sulfosulfuron, trifloxysulfuron), triazinylsulfonylurea herbicides (e.g., chlorsulfuron, cinosulfuron, ethametsulfuron, iodosulfuron, metsulfuron, prosulfuron, thifensulfuron, triasulfuron, tribenuron, triflusulfuron, tritosulfuron)); thiadiazolylurea herbicides (e.g., buthiuron, ethidimuron, tebuthiuron, thiazafluron, thidiazuron); unclassified herbicides (e.g., acrolein, allyl alcohol, aminocyclopyrachlor, azafenidin, bentazone, bentranil, benzobicyclon, bicyclopyrone, buthidazole, calcium cyanamide, cambendichlor, chlorfenac, chlorfenprop, chlorflurazole, chlorflurenol, cinmethylin, clomazone, CPMF, cresol, cyanamide, ortho-dichlorobenzene, dimepiperate, dithioether, endothal, fluoromidine, fluridone, flurochloridone, flurtamone, fluthiacet, indanofan, methoxyphenone, methyl isothiocyanate, OCH, oxaziclomefone, pelargonic acid, pentachlorophenol, pentoxazone, phenylmercury acetate, prosulfalin, pyribenzoxim, pyriftalid, quinoclamine, rhodethanil, sulglycapin, thidiazimin, tridiphane, trimeturon, tripropindan, tritac).

In some embodiments, the herbicide is a commercially available herbicide formulation comprising one or more herbicides. Examples include, but are not limited to, those described in Table 1 below.

TABLE 1

| Herbicide | Active Ingredient | Company | Crop/Use |
|---|---|---|---|
| ANTHEM | Pyroxasulfone, fluthiacet-methyl | FMC | BURNDOWN/PRE |
| ANTHEM ATZ | Pyroxasulfone, fluthiacet-methyl, atrazine | FMC | BURNDOWN/PRE |
| AUTHORITY ASSIST | Sulfentrazone, imazethapyr | FMC | BURNDOWN/FALL |
| AUTHORITY MAXX | Sulfentrazone, chlorimuron ethyl | FMC | BURNDOWN/FALL |
| AUTHORITY MTZ | Sulfentrazone, metribuzin | FMC | BURNDOWN/FALL |
| AUTHORITY XL | Sulfentrazone, chlorimuron ethyl | FMC | BURNDOWN/FALL |
| AUTUMN SUPER | Thiencarbazone-methyl, iodosulfuron-methyl | BAYER | BURNDOWN/FALL |
| BALANCE FLEXX | Isoxaflutole | BAYER | BURNDOWN/PRE |
| BASIS BLEND | Rimsulfuron, thifensulfuron | DUPONT | CORN |
| CLARITY | Dicamba | BASF | BURNDOWN |
| COBRA | Lactofen | VALENT | SOYBEAN |
| CORVUS | Isoxaflutole, thiencarbazone | BAYER | BURNDOWN/PRE |
| DISTINCT | Dicamba, diflufenzopyr | BASF | BURNDOWN/FALL |
| FIRSTRATE | Cloransulam | DOW | SOYBEAN |
| FLEXSTAR | Fomesafen | SYNGENTA | SOYBEAN |
| GRAMOXONE SL 2.0 | Paraquat | SYNGENTA | BURNDOWN |
| HARMONY EXTRA | Thifensulfuron, Tribenuron | DUPONT | WHEAT |
| INSTIGATE | Rimsulfuron, mesotrione | DUPONT | BURNDOWN/PRE |
| LAUDIS | Tembotrione | BAYER | CORN |
| LEADOFF | Rimsulfuron, thifensulfuron | DUPONT | BURNDOWN/PRE |
| MARVEL | Fluthiacet, fomesafen | FMC | SOYBEAN |
| OLYMPUS FLEX | Propoxycarbazone-sodium, mesosulfuron-methyl | BAYER | WHEAT |
| OPTllL PRO | Saflufenacil, imazethyapyr, dimethanimd-P | BASF | BURNDOWN/PRE |
| PANOFLEX | Tribenuron, thifensulfuron | DUPONT | BURNDOWN |
| POAST PLUS | Sethoxydim | BASF | SOYBEAN |
| PURSUIT | Imazethapyr | BASF | SOYBEAN |
| RAPTOR | Imazamox | BASF | SOYBEAN |
| REFLEX | Fomesafen | SYNGENTA | SOYBEAN |
| RESOLVE Q | Rimsulfuron, thifensulfuron | DUPONT | CORN |
| RESOURCE | Flumiclorac | VALENT | SOYBEAN |
| RIMFIRE | Mesosulfuron-methyl, propoxycarbazone-sodium | BAYER | WHEAT |
| RIMFIRE MAX | Mesosulfuron-methyl, propoxycarbazone-sodium | BAYER | WHEAT |
| SHARPEN | Saflufenacil | BASF | BURNDOWN |
| STATUS | Dicamba, diflufenzopyr | BASF | CORN |
| SYNCHRONY XP | Chlorimuron-ethyl, thifensulfuron-methyl | DUPONT | SOYBEAN |
| VALOR | Flumioxazin | VALENT | BURNDOWN/PRE |
| VERDICT | Saflufenacil, dimethenamid-P | BASF | BURNDOWN/PRE |

ii. Pesticides

Examples of pesticides include, but are not limited to, acaricides, avicides, chemosterilants, herbicides, insecticides, molluscicides, plant growth regulators, virucides, algicides, bactericides, fungicides, insect attractants, mammal repellents, nematicides, rodenticides, antifeedants, bird repellents, herbicide safeners, insect repellents, mating disrupters,

plant activators, synergists, chemical classes, and miscellaneous.

iii. Insecticides

Examples of insecticides include, but are not limited to, antibiotic insecticides (e.g., allosamidin, thuringiensin); macrocyclic lactone insecticides (e.g., avermectin insecticides (e.g., abamectin, doramectin, emamectin, eprinomectin, ivermectin, selamectin), milbemycin insecticides (e.g., lepimectin, milbemectin, milbemycin oxime, and moxidectin), spinosyn insecticides (e.g., spinetoram and spinosad)); arsenical insecticides (e.g., calcium arsenate, copper acetoarsenite, copper arsenate, lead arsenate, potassium arsenite, sodium arsenite); botanical insecticides (e.g., allicin, anabasine, azadirachtin, carvacrol, d-limonene, matrine, nicotine, nornicotine, oxymatrine, pyrethrins (e.g., cinerins, (e.g., cinerin I, cinerin II), jasmolin I, jasmolin II, pyrethrin I, pyrethrin II), quassia, rhodojaponin-III, rotenone, ryania, sabadilla, triptolide); carbamate insecticides (e.g., bendiocarb, carbaryl); benzofuranyl methylcarbamate insecticides (e.g., benfuracarb, carbofuran, carbosulfan, decarbofuran, furathiocarb); dimethylcarbamate insecticides (e.g., dimetan, dimetilan, hyquincarb, isolan, pirimicarb, pyramat); oxime carbamate insecticides (e.g., alanycarb, aldicarb, aldoxycarb, butocarboxim, butoxycarboxim, methomyl, nitrilacarb, oxamyl, tazimcarb, thiocarboxime, thiodicarb, thiofanox); phenyl methylcarbamate insecticides (e.g., allyxycarb, aminocarb, bufencarb, butacarb, carbanolate, cloethocarb, CPMC, dicresyl, dimethacarb, dioxacarb, EMPC, ethiofencarb, fenethacarb, fenobucarb, isoprocarb, methiocarb, metolcarb, mexacarbate, promacyl, promecarb, propoxur, trimethacarb, XMC, xylylcarb); desiccant insecticides (e.g., boric acid, diatomaceous earth, silica gel); diamide insecticides (e.g., chlorantraniliprole, cyantraniliprole, flubendiamide); dinitrophenol insecticides (e.g., dinex, dinoprop, dinosam, DNOC); fluorine insecticides (e.g., barium hexafluorosilicate, cryolite, flursulamid, sodium fluoride, sodium hexafluorosilicate, sulfluramid); formamidine insecticides (e.g., amitraz, chlordimeform, formetanate, formparanate, medimeform, semiamitraz); fumigant insecticides (e.g., acrylonitrile, carbon disulfide, carbon tetrachloride, chloroform, chloropicrin, paradichlorobenzene, 1,2-dichloropropane, dithioether, ethyl formate, ethylene dibromide, ethylene dichloride, ethylene oxide, hydrogen cyanide, methyl bromide, methyl iodide, methylchloroform, methylene chloride, naphthalene, phosphine, sulfuryl fluoride, tetrachloroethane); inorganic insecticides (e.g., borax, boric acid, calcium polysulfide, copper oleate, diatomaceous earth, mercurous chloride, potassium thiocyanate, silica gel, sodium thiocyanate, see also arsenical insecticides, see also fluorine insecticides); insect growth regulators (e.g., chitin synthesis inhibitors (e.g., bistrifluron, buprofezin, chlorbenzuron, chlorfluazuron, cyromazine, dichlorbenzuron, diflubenzuron, flucycloxuron, flufenoxuron, hexaflumuron, lufenuron, novaluron, noviflumuron, penfluron, teflubenzuron, triflumuron); juvenile hormone mimics (e.g., dayoutong, epofenonane, fenoxycarb, hydroprene, kinoprene, methoprene, pyriproxyfen, triprene); juvenile hormones (e.g., juvenile hormone I, juvenile hormone II, juvenile hormone III); moulting hormone agonists (e.g., chromafenozide,

furan tebufenozide, halofenozide, methoxyfenozide, tebufenozide, yishijing); moulting hormones (e.g., a-ecdysone, ecdysterone); moulting inhibitors (e.g., diofenolan); precocenes (e.g., precocene I, precocene II, precocene III); unclassified insect growth regulators (e.g., dicyclanil)); nereistoxin analogue insecticides (e.g., bensultap, cartap, polythialan, thiocyclam, thiosultap); nicotinoid insecticides (e.g., flonicamid); nitroguanidine insecticides (e.g., clothianidin, dinotefuran, imidacloprid, imidaclothiz, thiamethoxam); nitromethylene insecticides (e.g., nitenpyram, nithiazine); pyridylmethylamine insecticides (e.g., acetamiprid, imidacloprid, nitenpyram, paichongding, thiacloprid); organochlorine insecticides (e.g., bromo-DDT, camphechlor, DDT (e.g., pp′-DDT), ethyl-DDD, HCH (e.g., gamma-HCH, lindane), methoxychlor, pentachlorophenol, TDE); cyclodiene insecticides (e.g., aldrin, bromocyclen, chlorbicyclen, chlordane, chlordecone, dieldrin, dilor, endosulfan (e.g., alpha endosulfan), endrin, HEOD heptachlor, HHDN, isobenzan, isodrin, kelevan, mirex), organophosphorus insecticides (e.g., organophosphate insecticides (e.g., bromfenvinfos, calvinphos, chlorfenvinphos, crotoxyphos, dichlorvos, dicrotophos, dimethylvinphos, fospirate, heptenophos, methocrotophos, mevinphos monocrotophos, naled, naftalofos, phosphamidon, propaphos, TEPP, tetrachlorvinphos); organothiophosphate insecticides (e.g., dioxabenzofos, fosmethilan, phenthoate); aliphatic organothiophosphate insecticides (e.g., acethion, acetophos, amiton, cadusafos, chlorethoxyfos, chlormephos, demephion (e.g., demephion-O, demephion-S), demeton (e.g., demeton-O, demeton-S), demeton methyl (e.g., demeton-O-methyl, demeton-S-methyl), disulfoton, ethion ethoprophos, IP SP, isothioate, malathion, methacrifos, methylacetophos, oxydemetonmethyl, oxydeprofos, oxydisulfoton, phorate, sulfotep, terbufos, thiometon); aliphatic amide organothiophosphate insecticides (e.g., amidithion, cyanthoate, dimethoate, ethoate-methyl, formothion, mecarbam, omethoate, prothoate, sophamide, vamidothion), oxime organothiophosphate insecticides (e.g., chlorphoxim, phoxim, phoxim-methyl); heterocyclic organothiophosphate insecticides (e.g., azamethiphos, colophonate, coumaphos, coumithoate, dioxathion, endothion, menazon, morphothion, phosalone, pyraclofos, pyridaphenthion, quinothion); benzothiopyran organothiophosphate insecticides (e.g., dithicrofos, thicrofos); benzotriazine organothiophosphate insecticides (e.g., azinphos-ethyl, azinphos-methyl); isoindole organothiophosphate insecticides (e.g., dialifos, phosmet); isoxazole organothiophosphate insecticides (e.g., isoxathion, zolaprofos); pyrazolopyrimidine organothiophosphate insecticides (e.g., chlorprazophos, pyrazophos); pyridine organothiophosphate insecticides (e.g., chlorpyrifos, chlorpyrifos-methyl); pyrimidine organothiophosphate insecticides (e.g., butathiofos, diazinon, etrimfos, lirimfos, pirimioxyphos pirimiphos-ethyl, pirimiphos-methyl, primidophos, pyrimitate, tebupirimfos); thiadiazole organothiophosphate insecticides (e.g., athidathion, lythidathion, methidathion, prothidathion); triazole organothiophosphate insecticides (e.g., isazofos, triazophos); phenyl organothiophosphate insecticides (e.g., azothoate, bromophos, bromophos-ethyl, carbophenothion, chlorthiophos, cyanophos, cythioate, dicapthon, dichlofenthion, etaphos, famphur, fenchlorphos, fenitrothion, fensulfothion, fenthion, fenthion-ethyl, heterophos, jodfenphos, mesulfenfos, parathion, parathion-methyl, phenkapton, phosnichlor, profenofos, prothiofos, sulprofos, temephos, trichlormetaphos-3, trifenofos, xiaochongliulin)); phosphonate insecticides (e.g., butonate, trichlorfon); phosphonothioate insecticides (e.g., mecarphon); phenyl ethylphosphonothioate insecticides (e.g., fonofos, trichloronat); phenyl phenylphosphonothioate insecticides (e.g., cyanofenphos, EPN, leptophos); phosphoramidate insecticides (e.g., crufomate, fenamiphos, fosthietan, mephosfolan, phosfolan, phosfolan-methyl pirimetaphos); phosphoramidothioate insecticides (e.g., dimefox, mazidox, mipafox, schradan); oxadiazine insecticides (e.g., indoxacarb); oxadiazolone insecticides (e.g., metoxadiazone); phthalimide insecticides (e.g., dialifos, phosmet, tetramethrin); pyrazole insecticides (e.g., chlorantraniliprole, cyantraniliprole, dimetilan, isolan, tebufenpyrad, tolfenpyrad); phenylpyrazole insecticides (e.g., acetoprole, ethiprole, fipronil, pyraclofos, pyrafluprole, pyriprole, vaniliprole); pyrethroid insecticides (e.g., pyrethroid ester insecticides (e.g., acrinathrin, allethrin (e.g., bioallethrin, esdepallethrine), barthrin, bifenthrin, bioethanomethrin brofenvalerate, brofluthrinate, bromethrin, butethrin, chlorempenthrin, cyclethrin, cycloprothrin cyfluthrin (e.g., beta-cyfluthrin), cyhalothrin (e.g., gamma-cyhalothrin, lambda-cyhalothrin), cypermethrin (e.g., alpha-cypermethrin, beta-cypermethrin, theta-cypermethrin, zeta-cypermethrin), cyphenothrin, deltamethrin, dimefluthrin, dimethrin, empenthrin, d-fanshiluquebingjuzhi, fenfluthrin, fenpirithrin, fenpropathrin, fenvalerate (e.g., esfenvalerate), flucythrinate, fluvalinate (e.g., tau fluvalinate), furamethrin, furethrin, imiprothrin, japothrins, kadethrin, meperfluthrin, methothrin, metofluthrin, pentmethrin, permethrin (e.g., biopermethrin, transpermethrin), phenothrin, prallethrin, profluthrin, proparthrin, pyresmethrin, resmethrin (e.g., bioresmethrin, cismethrin), tefluthrin, terallethrin, tetramethrin, tetramethylfluthrin, tralocythrin, tralomethrin, transfluthrin, valerate; pyrethroid ether insecticides (e.g., etofenprox, flufenprox, halfenprox, protrifenbute, silafluofen); pyrethroid oxime insecticides (e.g., sulfoxime, thiofluoximate)); pyrimidinamine insecticides (e.g., flufenerim, pyrimidifen); pyrrole insecticides (e.g., chlorfenapyr); tetramic acid insecticides (e.g., spirotetramat); tetronic acid insecticides (e.g., spiromesifen); thiazole insecticides (e.g., clothianidin, imidaclothiz, thiamethoxam, thiapronil); thiazolidine insecticides (e.g., tazimcarb, thiacloprid); thiourea insecticides (e.g., diafenthiuron); urea insecticides (e.g., flucofuron, sulcofuron, see also chitin synthesis inhibitors); unclassified insecticides (e.g., closantel, copper naphthenate, crotamiton EXD, fenazaflor, fenoxacrim, hydramethylnon, isoprothiolane malonoben, metaflumizone,nifluridide, plifenate, pyridaben, pyridalyl, pyrifluquinazon, rafoxanide, sulfoxaflor, triarathene, triazamate).

iv. Fungicides

Examples of fungicides include, but are not limited to aliphatic nitrogen fungicides (e.g., butylamine, cymoxanil, dodicin, dodine, guazatine, iminoctadine); amide fungicides (e.g., carpropamid, chloraniformethan, cyflufenamid, diclocymet, ethaboxam, fenoxanil, flumetover, furametpyr, isopyrazam, mandipropamid, penthiopyrad, prochloraz, quinazamid, silthiofam, triforine, xiwojunan); acylamino acid fungicides (e.g., benalaxyl (e.g., benalaxyl-M), furalaxyl, metalaxyl (e.g., metalaxyl-M), pefurazoate, valifenalate); anilide fungicides (e.g., benalaxyl (e.g., benalaxyl-M), bixafen, boscalid, carboxin, fenhexamid, fluxapyroxad, isotianil, metalaxyl (e.g., metalaxyl-M), metsulfovax, ofurace, oxadixyl, oxycarboxin, penflufen, pyracarbolid, sedaxane, thifluzamide, tiadinil, vangard); benzanilide fungicides (e.g., benodanil, flutolanil, mebenil, mepronil, salicylanilide, tecloftalam); furanilide fungicides (e.g., fenfuram, furalaxyl, furcarbanil, methfuroxam); sulfonanilide fungicides (e.g., flusulfamide); benzamide fungicides (e.g., benzohydroxamic acid, fluopicolide, fluopyram, tioxymid, trichlamide, zarilamid, zoxamide); furamide fungicides (e.g., cyclafuramid, furmecyclox); phenylsulfamide fungicides (e.g., dichlofluanid, tolylfluanid); sulfonamide fungicides (e.g., amisulbrom, cyazofamid); valinamide fungicides (e.g., benthiavalicarb, iprovalicarb); antibiotic fungicides (e.g., aureofungin, blasticidin-S, cycloheximide, griseofulvin, kasugamycin, moroxydine, natamycin, polyoxins, polyoxorim, streptomycin, validamycin); strobilurin fungicides (e.g., azoxystrobin, dimoxystrobin, enestroburin, fluoxastrobin, jiaxiangjunzhi, kresoxim-methyl, metominostrobin, orysastrobin, picoxystrobin, pyraclostrobin, pyrametostrobin, pyraoxystrobin, trifloxystrobin, xiwojunan); aromatic fungicides (e.g., biphenyl, chlorodinitronaphthalenes, chloroneb, chlorothalonil, cresol, dicloran, hexachlorobenzene, pentachlorophenol, quintozene, sodium pentachlorophenoxide, tecnazene); arsenical fungicides (e.g., asomate, urbacide); aryl phenyl ketone fungicides (e.g., metrafenone, pyriofenone); benzimidazole fungicides (e.g., benomyl

carbendazim, chlorfenazole, cypendazole, debacarb, fuberidazole, mecarbinzid, rabenzazole, thiabendazole); benzimidazole precursor fungicides (e.g., furophanate, thiophanate, thiophanate-methyl); benzothiazole fungicides (e.g., bentaluron, benthiavalicarb, benthiazole, chlobenthiazone, probenazole); botanical fungicides (e.g., allicin, berberine, carvacrol, carvone, osthol); bridged diphenyl fungicides (e.g., bithionol, dichlorophen, diphenylamine, hexachlorophene, parinol); carbamate fungicides (e.g., benthiavalicarb, furophanate, iprovalicarb, propamocarb, pyribencarb, thiophanate, thiophanate-methyl); benzimidazolylcarbamate fungicides (e.g., benomyl, carbendazim, cypendazole, debacarb, mecarbinzid); carbanilate fungicides (e.g., diethofencarb, lvdingjunzhi, pyraclostrobin, pyrametostrobin); conazole fungicides (e.g., conazole fungicides (imidazoles) (e.g., climbazole,
clotrimazole, imazalil, oxpoconazole, prochloraz, triflumizole, see also imidazole fungicides), conazole fungicides (triazoles) (e.g., azaconazole, bromuconazole, cyproconazole, diclobutrazol, difenoconazole, diniconazole (e.g., diniconazole-M), epoxiconazole, etaconazole, fenbuconazole, fluquinconazole, flusilazole, flutriafol, furconazole (e.g., furconazole-cis), hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, uniconazole-P, see also triazole fungicides)); copper fungicides (e.g., Bordeaux mixture, Burgundy mixture, Cheshunt mixture, copper acetate, copper carbonate, basic copper hydroxide, copper naphthenate, copper oleate, copper oxychloride, copper silicate, copper sulfate, copper sulfate, basic, copper zinc chromate, cufraneb, cuprobam, cuprous oxide, mancopper, oxine-copper, saisentong); cyanoacrylate fungicides (e.g., benzamacril, phenamacril); dicarboximide fungicides (e.g., famoxadone, fluoroimide); dichlorophenyl dicarboximide fungicides (e.g., chlozolinate, dichlozoline, iprodione, isovaledione, myclozolin, procymidone, vinclozolin); phthalimide fungicides (e.g., captafol, captan, ditalimfos, folpet, thiochlorfenphim); dinitrophenol fungicides (e.g., binapacryl, dinobuton, dinocap (e.g., dinocap-4, dinocap-6, meptyldinocap), dinocton, dinopenton, dinosulfon, dinoterbon, DNOC); dithiocarbamate fungicides (e.g., amobam, asomate, azithiram, carbamorph, cufraneb, cuprobam, disulfiram, ferbam, metam, nabam, tecoram, thiram, urbacide, ziram); cyclic dithiocarbamate fungicides (e.g., dazomet, etem, milneb); polymeric dithiocarbamate fungicides (e.g., mancopper, mancozeb, maneb, metiram, polycarbamate, propineb, zineb); dithiolane fungicides (e.g., isoprothiolane, saijunmao); fumigant fungicides (e.g., dithioether, methyl bromide); hydrazide fungicides (e.g., benquinox, saijunmao); imidazole fungicides (e.g., cyazofamid, fenamidone, fenapanil, glyodin, iprodione, isovaledione, pefurazoate, triazoxide, see also conazole fungicides (imidazoles)); inorganic fungicides (e.g., potassium azide, potassium thiocyanate, sodium azide, sulfur, see also copper fungicides, see also inorganic mercury fungicides); mercury fungicides (e.g., inorganic mercury fungicides (e.g., mercuric chloride, mercuric oxide, mercurous chloride), organomercury fungicides (e.g., (3-ethoxypropyl)mercury bromide, ethylmercury acetate, ethylmercury bromide, ethylmercury chloride, ethylmercury 2,3-dihydroxypropyl mercaptide, ethylmercury phosphate, N-(ethylmercury)-ptoluenesulphonanilide, hydrargaphen, 2-methoxyethylmercury chloride, methylmercury benzoate, methylmercury dicyandiamide, methylmercury pentachlorophenoxide, 8-phenylmercurioxyquinoline, phenylmercuriurea, phenylmercury acetate, phenylmercury chloride, phenylmercury derivative of pyrocatechol, phenylmercury nitrate, phenylmercury salicylate, thiomersal, tolylmercury acetate)); morpholine fungicides (e.g., aldimorph, benzamorf, carbamorph, dimethomorph, dodemorph, fenpropimorph, flumorph, tridemorph); organophosphorus fungicides (e.g., ampropylfos, ditalimfos, EBP, edifenphos, fosetyl, hexylthiofos, inezin, iprobenfos, izopamfos, phosdiphen, pyrazophos, tolclofos-methyl, triamiphos); organotin fungicides (e.g., decafentin, fentin, tributyltin oxide); oxathiin fungicides (e.g., carboxin, oxycarboxin); oxazole fungicides (e.g., dichlozoline, dingjunezuo, drazoxolon, famoxadone, hymexazol, metazoxolon, myclozolin, oxadixyl, vinclozolin); polysulfide fungicides (e.g., barium polysulfide, calcium polysulfide, potassium polysulfide, sodium polysulfide); pyrazole fungicides (e.g., bixafen, fluxapyroxad, furametpyr, isopyrazam, penflufen, penthiopyrad, pyraclostrobin, pyrametostrobin, pyraoxystrobin, rabenzazole, sedaxane); pyridine fungicides (e.g., boscalid, buthiobate, dingjunezuo, dipyrithione, fluazinam,
10 fluopicolide, fluopyram, lvdingjunzhi, parinol, pyribencarb, pyridinitril, pyrifenox, pyroxychlor, pyroxyfur); pyrimidine fungicides (e.g., bupirimate, diflumetorim, dimethirimol, ethirimol, fenarimol, ferimzone, nuarimol, triarimol); anilinopyrimidine fungicides (e.g., cyprodinil, mepanipyrim, pyrimethanil); pyrrole fungicides (e.g., dimetachlone, fenpiclonil, fludioxonil, fluoroimide); quinoline fungicides (e.g., ethoxyquin, halacrinate, 8-hydroxyquinoline sulfate, quinacetol, quinoxyfen, tebufloquin); quinone fungicides (e.g., benquinox, chloranil, dichlone, dithianon); quinoxaline fungicides (e.g., chinomethionat, chlorquinox, thioquinox); thiazole fungicides (e.g., ethaboxam, etridiazole, isotianil, metsulfovax, octhilinone, thiabendazole, thifluzamide); thiazolidine fungicides (e.g., flutianil, thiadifluor); thiocarbamate fungicides (e.g., methasulfocarb, prothiocarb); thiophene fungicides
(e.g., ethaboxam, silthiofam); triazine fungicides (e.g., anilazine); triazole fungicides (e.g., amisulbrom, bitertanol, fluotrimazole, huanjunzuo, triazbutil, see also conazole fungicides (triazoles)); triazolopyrimidine fungicides (e.g., ametoctradin); urea fungicides (e.g., bentaluron, pencycuron, quinazamid); unclassified fungicides (e.g., acibenzolar, acypetacs, allyl alcohol, benzalkonium chloride, bethoxazin, bromothalonil, chloropicrin, DBCP, dehydroacetic acid, diclomezine, diethyl pyrocarbonate, ethylicin, fenaminosulf, fenitropan, fenpropidin, formaldehyde, furfural, hexachlorobutadiene, methyl iodide, methyl isothiocyanate, nitrostyrene,
nitrothal-isopropyl, OCH, 2-phenylphenol, phthalide, piperalin, propamidine, proquinazid, pyroquilon, sodium orthophenylphenoxide, spiroxamine, sultropen, thicyofen, tricyclazole, zinc naphthenate).

In some embodiments, compositions comprise high fructose corn syrup as an additional component.

### B. Adjuvants

Compositions of embodiments of the present invention further comprise an adjuvant (e.g., modified seed oil). As used herein, the term “modified seed oil” refers to a seed oil that is not in its natural environment. In some embodiments, a modified seed oil is modified by removing it from its natural environment. In some embodiments, a modified seed oil is chemically modified from its natural state. It some embodiments, modified seed oils are synthetic seed oils (e.g., chemically synthesized outside their natural environment). In some embodiments, modified seed oils are in formulations or combinations different than those found in nature.

In some embodiments, the modified seed oil is a methylated seed oil. Examples of methylated seed oils include, but are not limited to, methyl caprylate-caprate, methyl laurate, methyl myristate, methyl palmitate, methyl stearate, methyl oleate, methyl coconate, methyl sunflowerate, methyl canolate, and methyl soyate.

In some embodiments, the modified seed oil is a paraffinic oil or modified vegetable oil. In some embodiments, the modified seed oil is a phytobland oil derived from petroleum sources with a minimum unsulfonated residue value of, for example, 92% or an oil derived from seeds such as, but not limited to, soybean oil, canola oil, sunflower oil, linseed oil, cottonseed oil, or corn oil.

### C. Enhancers

In some embodiments, compositions comprise one or more enhancers (e.g., plant extracts (e.g., essential oils) or terpenes). In some embodiments, the enhancer component increases the efficacy of the herbicide or other agricultural product. While not being limited to a particular mechanism, it is contemplated that enhancers such as essential oils improve the efficacy of agricultural products by solubilizing the cuticle waxes of plants.

Examples of essential oils suitable for use as enhancers include, but are not limited to, almond, sweet; almond, bitter; amyris; angelica root; angelica seed; anise; balsam Peru; basil;

bay; bergamot Italian; birch sweet southern; bois de rose Brazil; camphor white; camphor 1070; cananga java native; caraway seed; cassia redistilled; cedarleaf, thuja occidentals; cedarwood Texas; cedarwood Virginia; celery seed; cinnamon bark extra; cinnamon; cinnamon leaf Ceylon; citronella Ceylon; citronella 5/35% Java; clary sage extra; clove bud; clove leaf Indonesia; clove leaf Madagascar; clove leaf redistilled; clove stem; copaiba; coriander; cumin; dill weed; estragon; eucalyptus 70/75%; eucalyptus 80/85%; fennel sweet; fir Canadian; fir Siberian; galbanum; garlic; gaultheria southern; geranium bourbon; geranium Chinese; geranium Egyptian; ginger; grapefruit CP pink; grapefruit CP white; grapefruit expressed; guaiacwood concentrate; hemlock; hyssop; juniper berries; lavandin abrialis 30/32%; lavandin grosso; lavender fleurs 40/42%; lavender spike; lemon calif. type star brand; lemon CP Argentina; lemon Italian extra; lemongrass Guatemala; lime expressed; lime expressed Mexican; lime distilled Mexican; lime distilled Peru; litsea cubeba; mace distilled; mandarin Italian; marjoram sweet Spanish; neroli bigarade; nutmeg; orange bitter West Indian; orange Brazil sweet; orange Brazil; orange distilled Cal.; orange sweet cold pressed Cal.; orange sweet expressed Fla. Valencia; orange sweet expressed Fla. mid season; origanum rectified; origanum vulgares; orris concrete; palmarosa; patchouli amber; patchouli dark; patchouli light; patchouli Md.; pennyroyal European; pepper black; peppermint natural star brand; peppermint natural; peppermint redistilled star brand; peppermint redistilled; petitgrain redistilled; petitgrain Sa; pimenta berries; pimenta leaf 80/85; pine needles Siberian; rosemary; sage dalmation; sage Spanish; sandalwood East Indian; spearmint; spearmint redistilled; spruce; tangerine Florida; tangerine California; tangerine dancy type; tarragon; thuja; thyme red; thyme white; vetivert bourbon; vetivert Java; wintergreen southern; wormwood American; ylang ylang bourbon extra; ylang ylang bourbon first; ylang ylang bourbon second; and ylang ylang bourbon third oils. Essential oils are commercially available (e.g., from Ungerer and Company, Bethlehem, Pa.).

In some embodiments, the enhancer is methyl salicylate (wintergreen oil). Methyl salicylate has the chemical structure

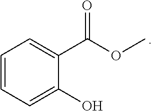

In some embodiments, methyl salicylate is utilized to enhance the activity of an herbicide and also to mask unpleasant odors from herbicides.

In some embodiments, enhancers are terpenes. Terpenes are often found in plant essential oils. Terpenes are a large and diverse class of organic compounds, produced by a variety of plants, particularly conifers, though also by some insects such as termites or swallowtail butterflies, which emit terpenes from their osmeteria. Many terpenes are aromatic hydrocarbons and thus may have mask unpleasant odors. The difference between terpenes and terpenoids is that terpenes are hydrocarbons, whereas terpenoids contain additional functional groups. Terpenes are derived biosynthetically from units of isoprene, which has the molecular formula C₅H₈. The basic molecular formulae of terpenes are multiples of that, (C₅H₈)ₙ where n is the number of linked isoprene units.

Exemplary terpenes are described herein. Hemiterpenes comprise a single isoprene unit. Isoprene itself is considered the only hemiterpene, but oxygen-containing derivatives such as prenol and isovaleric acid are hemiterpenoids.

Monoterpenes comprise two isoprene units and have the molecular formula C₁₀H₁₆. Examples of monoterpenes include, but are not limited to, geraniol, limonene and terpineol.

Sesquiterpenes comprise three isoprene units and have the molecular formula C₁₅H₂₄. Examples of sesquiterpenes include, but are not limited to, humulene, farnesenes, farnesol. (The sesqui-prefix means one and a half.)

Diterpenes comprise four isoprene units and have the molecular formula C₂₀H₃₂. They derive from geranylgeranyl pyrophosphate. Examples of diterpenes include, but are not limited to, cafestol, kahweol, cembrene and taxadiene (precursor of taxol). Diterpenes also form the basis for biologically important compounds such as retinol, retinal, and phytol. They are known to be antimicrobial and antiinflammatory.

Sesterterpenes, terpenes having 25 carbons and five isoprene units, are rare relative to the other sizes. (The sester-prefix means half to three, e.g., two and a half.) An example of a sesterterpene is geranylfarnesol.

Triterpenes comprise six isoprene units and have the molecular formula C₃₀H₄₈. The linear triterpene squalene, the major constituent of shark liver oil, is derived from the reductive coupling of two molecules of farnesyl pyrophosphate. Squalene is then processed biosynthetically to generate either lanosterol or cycloartenol, the structural precursors to all the steroids.

Sesquarterpenes comprises seven isoprene units and have the molecular formula C₃₅H₅₆. Sesquarterpenes are typically microbial in their origin. Examples of sesquarterpenes include, but are not limited to, ferrugicadiol and tetraprenylcurcumene.

Tetraterpenes comprise eight isoprene units and have the molecular formula C₄₀H₆₄. Biologically important tetraterpenes include, but are not limited to, the acyclic lycopene, the monocyclic gamma-carotene, and the bicyclic alpha- and beta-carotenes.

Polyterpenes comprise long chains of many isoprene units. Natural rubber comprises polyisoprene in which the double bonds are cis. Some plants produce a polyisoprene with trans double bonds, known as gutta-percha.

Norisoprenoids, such as the C13-norisoprenoids 3-oxo-α-ionol present in Muscat of Alexandria leaves and 7,8-dihydroionone derivatives, such as megastigmane-3,9-diol and 3-oxo-7,8-dihydro-α-ionol found in Shiraz leaves (both grapes in the species Vitis vinifera) or wine (responsible for some of the spice notes in Chardonnay), can be produced by fungal peroxydases or glycosidases.

In some embodiments, enhancers are lecithin (e.g. hydroxylated lecithin) or modified lecithin. In some embodiments, the lecithin is a commercially available lecithin such as Centrol3F UB from Central Soya, Leciprime from Riceland Foods, Inc., and M-C-THIN AF-S/AB from Lucas Meyer, Inc.

### D. Emulsifiers

In some embodiments, compositions comprise an emulsifier. Examples of emulsifiers include, but are not limited to, surfactants, lecithin, salts of ligninsulfonic acid, Toximul 8242, Toximul TA-5, Atlox 4838B, alkylphenol ethoxylates, alcohol ethoxylates, polyoxyethylene glycol estehr, polyl fatty acid esters, alkyl ethoxylates, alkylarylpolyoxyalkane ether, sorbitan fatty acid esters alkylphenol ethyoxylates, tall fatty acids, ethoxylate alkyl aryl phosphate, polyoxyethylene sorbitan fatty acid esters, AU-110, Emulsifier D, Emulsifier F, and nonylphenol ethoxylates.

### E. Formulations

In some embodiments, the present disclosure provides agricultural formulations comprising one or more of the above described components in a variety of concentrations. In some embodiments, formulations include 1-20% (w/w) enhancer (e.g., 2-18%, 3-15%, 4-12%, or 5-10%). In some embodiments, formulations comprise emulsifier at a concentration of 1 to 60% (e.g., 2-20%, 5-15%, or 5-10%). In some embodiments, agricultural product, enhancer, and emulsifier, along with additional optional components (e.g., those described herein) are emulsified in adjuvant (e.g., methylated seed oil or other neutral oil).

In some embodiments, formulations comprise a formulation shown in Table 1 below, although additional formulations are specifically contemplated.

TABLE 1

| | | % of Formulation |
|---|---|---|
| | Component | (by weight) |
| Formulation I | Emulsifier | 10 |
| | Methylated Soybean Oil | 80 |
| | Methyl Salicylate | 10 |
| Formulation II | Emulsifier | 10 |
| | Methylated Soybean Oil | 80 |
| | Hydroxylated Lecithin | 10 |

In some embodiments, agricultural formulations are diluted in water or other liquid prior to use. For example, in some embodiments, herbicide formulations are diluted approximately 0.5-1.0% by volume or at a concentration of 1-2 pints/acre.

### II. Uses

The agricultural compositions described herein find use in a variety of agricultural, research, home, and landscaping applications.

In some embodiments, compositions are provided in a kit or system in combination with a device for applying the composition or dilution thereof. In some embodiments, device is a sprayer or other application device. The particular choice of application device depends on the agricultural product, application, and scale of application (e.g., size of the plot or field that the agricultural product is applied to). A variety of systems for application of agricultural products are commercially available.

In some embodiments, compositions are applied by licensed or regulated operators. The use of certain herbicides or other agricultural products is regulated at the state level and regulations vary depending on the particular agricultural product and the state that it is being used in. In some embodiments, the compositions described herein find use in agricultural application to prevent weeds, plant disease, pests, etc. The present disclosure is not limited to a particular agricultural crop. Examples include, but are not limited to, corn, soybeans, grain, and vegetables. In some embodiments, the herbicide composition is applied prior to seeding an agricultural crop, after an agricultural crop has emerged, or after harvest of an agricultural crop.

### EXAMPLES

The following examples are presented in order to provide certain exemplary embodiments of the present invention and are not intended to limit the scope thereof.

### Example 1

Separate field trials were conducted with a tank mixture of Roundup PowerMax (glyphosate) at 11 fl oz/ac+Sharpen (saflufenacil) at 0.5 fl oz/ac and Roundup PowerMax at 11 fl oz/ac+Clarity (dicamba) at 4 oz/ac. In each trial, the herbicide mixture was applied alone or with the above-described adjuvants or a commercial methylated seed oil adjuvant standard (Succeed). All adjuvants were used at a rate of 1 pt/ac. Formulation I and II are described above. Data from each trial is presented in Tables 2 and 3.

TABLE 2
Roundup PowerMax (RUP) + Sharpen (SH) control of weeds.

| | | Common chickweed | Purple deadnettle |
|---|---|---|---|
| Treatment | Spray | control 38 days | control 6 days |
| number | mixture | after treatment | after treatment |
| 1 | RUP + SH | 73 | 33 |
| 2 | RUP + SH + | 70 | 50 |
| | Succeed | | |
| 3 | RUP + SH + | 78 | 53 |
| | Formulation I | | |
| 4 | RUP + SH + | 72 | 57 |
| | Formulation II | | |

TABLE 3
Roundup PowerMax (RUP) + Clarity (CL) control of weeds.

| | | Marestail control | Common chickweed |
|---|---|---|---|
| Treatment | Spray | 38 days | control 38 days |
| number | mixture | after treatment | after treatment |
| 1 | RUP + CL | 53 | 70 |
| 2 | RUP + CL + | 60 | 72 |
| | Succeed | | |
| 3 | RUP + CL + | 63 | 80 |
| | Formulation I | | |
| 4 | RUP + CL + | 67 | 80 |
| | Formulation II | | |

In the Roundup PowerMax+Sharpen trial, the inclusion of an adjuvant in the spray mixture increased control of either common chickweed or purple deadnettle (Table 2). Control of common chickweed increased when hydroxylated lecithin (Formulation II) was included in the adjuvant formulation. Control of purple deadnettle increased when hydroxylated lecithin (Formulation II) was included in the adjuvant formulation.

In the Roundup PowerMax+Clarity trial, the inclusion of an adjuvant in the spray mixture increased control of either marestail or common chickweed (Table 3). Control of marestail increased when hydroxylated lecithin (Formulation II) was included in the adjuvant formulation. Control of common chickweed increased when either methyl salicylate (Formulation I) or hydroxylated lecithin (Formulation II) was included in the adjuvant formulation.

### Example 2

Additional field trials were performed that compared Sharpen (active ingredient: saflufenacil ([2-chloro-4-fluoro-5-(3-methyl-2,6-dioxo-4-(trifluoromethyl)-3, 6-dihydro-1(2H)-pyrimidinyl)benzoyl]-N-isopropyl-N-methylsulfamide)) or Clarity (active ingredient: diglycolamine salt of 3,6-dichloro-o-anisic acid) to formulations described herein. Results are shown in Tables 2 and 3.

TABLE 2

| | | | | Weed Scientific Name | | |
|---|---|---|---|---|---|---|
| | | | | Conyza | Chenopodium | |
| | | | | canadensis | album | Kochia sp. |
| | | | | Weed Common Name | | |
| | | | | | Common | |
| | | | | Marestail | Lambsquarters | Kochia sp. |
| | | | | Rating Type | | |
| | | | | Control (%) | Control (%) | Control (%) |
| | | | | Trt-Eval Interval | | |
| | | | | 7 Days After | 28 Days After | 14 Days After |
| No. | Product | Rate | Unit | Treatment | Treatment | Treatment |
| 1 | Sharpen | 0.5 | oz/ac | 64 | 12 | 12 |
| | Roundup PowerMax | 11 | oz/ac | | | |
| 2 | Sharpen | 0.5 | oz/ac | 81 | 57 | 60 |
| | Roundup PowerMax | 11 | oz/ac | | | |
| | 90% MSO&10% | 1 | pt/ac | | | |
| | Emulsifier | | | | | |
| 3 | Sharpen | 0.5 | oz/ac | 85 | 28 | 28 |
| | Roundup PowerMax | 11 | oz/ac | | | |
| | 87.5% MSO&2.5% | 1 | pt/ac | | | |
| | Methyl Salicylate&10% | | | | | |
| | Emulsifier | | | | | |
| 4 | Sharpen | 0.5 | oz/ac | 80 | 47 | 52 |
| | Roundup PowerMax | 11 | oz/ac | | | |
| | 85% MSO&5% Methyl | 1 | pt/ac | | | |
| | Salicylate&10% | | | | | |
| | Emulsifier | | | | | |
| 5 | Sharpen | 0.5 | oz/ac | 86 | 75 | 72 |
| | Roundup PowerMax | 11 | oz/ac | | | |
| | 80% MSO&10% Methyl | 1 | pt/ac | | | |
| | Salicylate&10% | | | | | |
| | Emulsifier | | | | | |
| 6 | Sharpen | 0.5 | oz/ac | 80 | 53 | 57 |
| | Roundup PowerMax | 11 | oz/ac | | | |
| | 87.5% MSO&2.5% | 1 | pt/ac | | | |
| | Hydroxylated | | | | | |
| | Lecithin&10% | | | | | |
| | Emulsifier | | | | | |
| 7 | Sharpen | 0.5 | oz/ac | 86 | 91 | 91 |
| | Roundup PowerMax | 11 | oz/ac | | | |
| | 85% MSO&5% | 1 | pt/ac | | | |
| | Hydroxylated | | | | | |
| | Lecithin&10% | | | | | |
| | Emulsifier | | | | | |
| 8 | Sharpen | 0.5 | oz/ac | 85 | 82 | 68 |
| | Roundup PowerMax | 11 | oz/ac | | | |
| | 80% MSO&10% | 1 | pt/ac | | | |
| | Hydroxylated | | | | | |
| | Lecithin&10% | | | | | |
| | Emulsifier | | | | | |
| 9 | Sharpen | 0.5 | oz/ac | 89 | 35 | 35 |
| | Roundup PowerMax | 11 | oz/ac | | | |
| | 80% MSO&5% Methyl | 1 | pt/ac | | | |
| | Salicylate&5% | | | | | |
| | Hydroxylated | | | | | |
| | Lecithin&10% | | | | | |
| | Emulsifier | | | | | |

| | | | |
|---|---|---|---|
| LSD (P = .05) | 6 | 6 | 10 |
| CV | 5.09 | 7.25 | 11.34 |

Replacement of MSO with 10% methyl salicylate or 7.5% or 10% hydroxylated lecithin increased control of glyphosate-resistant marestail with Sharpen tank mixed with Roundup PowerMax. The combination of 5% methyl salicylate and 5% hydroxylated lecithin gave the highest control of glyphosate-resistant marestail.

Replacement of MSO with 10% methyl salicylate or 7.5% or 10% hydroxylated lecithin increased control of common lambsquarters with Sharpen tank mixed with Roundup PowerMax.

Replacement of MSO with 10% methyl salicylate or 7.5% or 10% hydroxylated lecithin increased control of glyphosate-resistant kochia with Sharpen tank mixed with Roundup PowerMax.

TABLE 3

| | | | | Weed Scientific Name | | |
|---|---|---|---|---|---|---|
| | | | | Conyza | Chenopodium | |
| | | | | canadensis | album | Kochia sp. |
| | | | | Weed Common Name | | |
| | | | | | Common | |
| | | | | Marestail | Lambsquarters | Kochia sp. |
| | | | | Rating Type | | |
| | | | | Control (%) | Control (%) | Control (%) |
| | | | | Trt-Eval Interval | | |
| | | | | 7 Days After | 28 Days After | 14 Days After |
| No. | Product | Rate | Unit | Treatment | Treatment | Treatment |
| 1 | Clarity | 8 | oz/ac | 43 | 37 | 35 |
| | Roundup PowerMax | 11 | oz/ac | | | |
| 2 | Clarity | 8 | oz/ac | 52 | 42 | 42 |
| | Roundup PowerMax | 11 | oz/ac | | | |
| | 90% MSO&10% | 1 | pt/ac | | | |
| | Emulsifier | | | | | |
| 3 | Clarity | 8 | oz/ac | 47 | 53 | 43 |
| | Roundup PowerMax | 11 | oz/ac | | | |
| | 87.5% MSO&2.5% | 1 | pt/ac | | | |
| | Methyl Salicylate&10% | | | | | |
| | Emulsifier | | | | | |
| 4 | Clarity | 8 | oz/ac | 40 | 43 | 43 |
| | Roundup PowerMax | 11 | oz/ac | | | |
| | 85% MSO&5% Methyl | 1 | pt/ac | | | |
| | Salicylate&10% | | | | | |
| | Emulsifier | | | | | |
| 5 | Clarity | 8 | oz/ac | 39 | 47 | 43 |
| | Roundup PowerMax | 11 | oz/ac | | | |
| | 80% MSO&10% Methyl | 1 | pt/ac | | | |
| | Salicylate&10% | | | | | |
| | Emulsifier | | | | | |
| 6 | Clarity | 8 | oz/ac | 40 | 68 | 53 |
| | Roundup PowerMax | 11 | oz/ac | | | |
| | 87.5% MSO&2.5% | 1 | pt/ac | | | |
| | Hydroxylated | | | | | |
| | Lecithin&10% Emulsifier | | | | | |
| 7 | Clarity | 8 | oz/ac | 45 | 45 | 45 |
| | Roundup PowerMax | 11 | oz/ac | | | |
| | 85% MSO&5% | 1 | pt/ac | | | |
| | Hydroxylated | | | | | |
| | Lecithin&10% Emulsifier | | | | | |
| 8 | Clarity | 8 | oz/ac | 42 | 37 | 38 |
| | Roundup PowerMax | 11 | oz/ac | | | |
| | 80% MSO&10% | 1 | pt/ac | | | |
| | Hydroxylated | | | | | |
| | Lecithin&10% Emulsifier | | | | | |
| 9 | Clarity | 8 | oz/ac | 46 | 37 | 33 |
| | Roundup PowerMax | 11 | oz/ac | | | |
| | 80% MSO&5% Methyl | 1 | pt/ac | | | |
| | Salicylate&5% | | | | | |
| | Hydroxylated | | | | | |
| | Lecithin&10% Emulsifier | | | | | |

| | | | |
|---|---|---|---|
| LSD (P = .05) | 9 | 5 | 7.1 |
| | | 7 | |
| CV | 12.06 | 6.65 | 9.73 |

Methyl salicylate or hydroxylated lecithin did not increase control of glyphosate-resistant marestail with Clarity tank mixed with Roundup PowerMax.

Replacement of MSO with 10% methyl salicylate or 2.5% hydroxylated lecithin increased control of common lambsquarters with Clarity tank mixed with Roundup PowerMax.

Replacement of MSO with 2.5% hydroxylated lecithin increased control of common lambsquarters with Clarity tank mixed with Roundup PowerMax.

### Example 3

This example describes additional experiments using the compositions described in the present specification.

### Roundup PowerMax Plus Sharpen Trials

Each treatment was comprised of a mixture of Roundup PowerMax (glyphosate potassium) at 11 oz/ac plus Sharpen (saflufenacil) diluted and applied at 10 gallons/acre spray volume. A-110 is a polymeric nonionic and alkyl and aryl ethoxylate blend emulsifier commercially available from Adjuvants Unlimited (Tulsa, Okla). Emulsifier “D” is a blend of polyoxyalkenes and ethoxylated castor oil and other components. Treatment 1 did not include any adjuvant and treatments 2 to 7 included adjuvant formulations listed below.

| TREAT- | FORMU- | | METHYL | EMULSI- | EMULSI- |
|---|---|---|---|---|---|
| MENT | LATION | MSO | SALICYLATE | FIER | FIER % |
| 2 | I | 90 | 0 | AU-110 | 10 |
| 3 | II | 80 | 10 | AU-110 | 10 |
| 4 | III | 80 | 0 | D | 10 |
| 5 | IV | 70 | 10 | D | 10 |
| 6 | V | 90 | 0 | F | 10 |
| 7 | VI | 80 | 10 | F | 10 |

Trials were conducted in Indiana, North Dakota, and Ohio (1 location per state). Weed species varied by location but included glyphosate resistant marestail or kochia. Weed control (herbicide efficacy) evaluations were taken at approximately 7, 14, and 28 days after herbicides were applied.

Indiana

Adjuvants enhanced marestail control compared to no adjuvant. There was no increase in control when methyl salicylate was included in the formulation compared to methylated seed oil alone.

North Dakota

No differences in wheat control or common lambsquarters control was observed.

Adjuvants enhanced kochia control compared to no adjuvant. For kochia, the substitution of 10% methylated soybean oil for methyl salicylate increased control with the D emulsifier but not with the AU-110 or F emulsifier.

Ohio

Adjuvants enhanced marestail control compared to no adjuvant. There were no significant differences in marestail control by 27 days after treatment. At 14 days after treatment, marestail control was greater with methyl salicylate with D emulsifier and F emulsifiers. However, control was numerically greater when methyl salicylate was included in the formulation.

### Instigate Trials

Each treatment was comprised of Instigate applied at 3 oz product/ac, diluted and applied at 10 gallons/acre spray volume. Treatment 1 did not include any adjuvant and treatments 2 to 7 included adjuvant formulations listed below.

| TREAT- | FORMU- | | METHYL | EMULSI- | EMULSI- |
|---|---|---|---|---|---|
| MENT | LATION | MSO | SALICYLATE | FIER | FIER % |
| 2 | I | 90 | 0 | AU-110 | 10 |
| 3 | II | 80 | 10 | AU-110 | 10 |
| 4 | III | 80 | 0 | D | 10 |
| 5 | IV | 70 | 10 | D | 10 |
| 6 | V | 90 | 0 | F | 10 |
| 7 | VI | 80 | 10 | F | 10 |

Trials were conducted in Indiana, North Dakota, and Ohio (1 location per state).

Weed species varied by location but included glyphosate resistant marestail or kochia. Weed control (herbicide efficacy) evaluations were taken at approximately 7, 14, and 28 days after herbicides were applied.

Indiana

Adjuvants increased marestail control with Instigate compared to no adjuvant inclusion. The inclusion of methyl salicylate in the formulation did not increase marestail control.

North Dakota

There was no difference in wheat or common lambsquarters control with Instigate.

Adjuvants increased kochia control with Instigate compared to no adjuvant inclusion. At 27 days after treatment, kochia control was numerically greater when methyl salicylate was used in combination with methylated soybean oil, and AU-110 and F emulsifiers.

Ohio

Adjuvants increase marestail control with Instigate compared to no adjuvant inclusion. Methyl salicylate increased marestail control when used with methylated soybean oil and F emulsifier.

### Paraquat Concentrate Trials

Each treatment was comprised of Paraquat Concentrate applied at 0.45 pt product/ac, diluted and applied at 10 gallons/acre spray volume. Treatment 1 did not include any adjuvant and treatments 2 to 7 included adjuvant formulations listed below.

| TREAT- | FORMU- | | METHYL | EMULSI- | EMULSI- |
|---|---|---|---|---|---|
| MENT | LATION | MSO | SALICYLATE | FIER | FIER % |
| 2 | I | 90 | 0 | AU-110 | 10 |
| 3 | II | 80 | 10 | AU-110 | 10 |
| 4 | III | 80 | 0 | D | 10 |
| 5 | IV | 70 | 10 | D | 10 |
| 6 | V | 90 | 0 | F | 10 |
| 7 | VI | 80 | 10 | F | 10 |

Trials were conducted in Indiana, North Dakota, and Ohio (1 location per state).

Weed species varied by location but included glyphosate resistant marestail or kochia. Weed control (herbicide efficacy) evaluations were taken at approximately 7, 14, and 28 days after herbicides were applied.

Indiana

Adjuvants increased marestail control with Instigate compared to no adjuvant inclusion. The inclusion of methyl salicylate in the formulation did not increase marestail control.

North Dakota

Adjuvants increased wheat control and common lambsquarters control with Paraquat Concentrate compared to no adjuvant inclusion. Methyl salicylate did not increase control when included in any of the formulations.

Ohio

Adjuvants did not increase kochia control with Paraquat Concentrate.

All publications and patents mentioned in the present application are herein incorporated by reference. Various modification and variation of the described methods and compositions of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the relevant fields are intended to be within the scope of the following claims.

1. A composition comprising:
a) at least one herbicide, pesticide, insecticide, or fungicide;
b) at least one adjuvant;
c) at least one emulsifier; and
d) at least one enhancer.

2. The composition of claim 1, wherein said adjuvant is a modified seed oil.

3. The composition of claim 2, wherein said modified seed oil is a methylated seed oil.

4. The composition of claim 1, wherein said enhancer is an plant extract, a terpene, or a lecithin.

5. The composition of claim 4, wherein said plant extract is an essential oil.

6. The composition of claim 5, wherein said essential oil is methyl salicylate.

7. The composition of claim 1, wherein said enhancer is present at a concentration of between 1 and 20%.

8. The composition of claim 5, wherein said enhancer is present at a concentration of between 5 and 10%.

9. The composition of claim 1, wherein said emulsifier is selected from the group consisting of A-110, alkylphenol ethoxylates, alcohol ethoxylates, polyoxyethylene glycol estehr, polyl fatty acid esters, alkyl ethoxylates, alkylarylpolyoxyalkane ether, sorbitan fatty acid esters alkylphenol ethyoxylates, tall fatty acids, ethoxylate alkyl aryl phosphate, polyoxyethylene sorbitan fatty acid esters, and nonylphenol ethoxylates.

10. The composition of claim 1, wherein said emulsifier is present at a concentration of between 1 and 60%.

11. A composition comprising:
a) at least one herbicide, pesticide, insecticide, or fungicide;
b) at least one methylated seed oil;
c) at least one emulsifier; and
d) at least one essential oil.

12. A dilution of the composition of claim 1 in water.

13. The dilution of claim 12, wherein said composition is diluted to a concentration of 0.25 to 1.0% by volume.

14. A system, comprising:
a) the composition of claim 1 or a dilution thereof; and
b) a device for applying said composition or dilution thereof.

15. The system of claim 14, wherein said device is a sprayer.

16. A method of treating a plant, comprising applying the composition of claim 1 or a dilution thereof to said plant.

17. The method of claim 16, wherein said composition is applied prior to seeding an agricultural crop, after an agricultural crop has emerged, or after harvest of an agricultural crop.

18. The method of claim 16, wherein said applying results in enhancing plant growth, killing of a weed, killing of a pest, killing of a fungus, or killing of an insect.
